(19) United States
(12) Patent Application Publication
(10) Pub. No.: US 2015/0241874 A1
(43) Pub. Date: Aug. 27, 2015

(54) CONFIGURABLE GENERIC ELECTRICAL FACILITY

(71) Applicant: SAGEM DEFENSE SECURITE, Boulogne-Billancourt (FR)

(72) Inventors: Jean-Francois Agier, Boulogne Bilancourt (FR); Jean-Luc Manca, Boulogne Billancourt (FR)

(73) Assignee: SAGEM DEFENSE SECURITE, Boulogne-Billancourt (FR)

(21) Appl. No.: 14/434,061

(22) PCT Filed: Oct. 4, 2013
(86) PCT No.: PCT/EP2013/070735

§ 371 Date: Apr. 7, 2015

(30) Foreign Application Priority Data
Oct. 9, 2012 (FR) 1259629

(51) Int. Cl. G05B 19/418

(52) U.S. Cl. CPC G05B 19/41865; G05B 2219/32085

(57) ABSTRACT

Configurable generic electrical facility comprising processing means for implementing at least one configured function, the processing means comprising a processing unit, predefined functional blocks being implemented in the processing unit, the processing unit comprising a memory module designed to store configuration data, characterized in that the processing unit comprises routing means designed to connect the blocks and to organize data exchanges between the blocks according to interconnection data included in the configuration data stored in the memory module 5.

The invention relates to a configurable generic electrical facility comprising processing means for implementing various applications.

### BACKGROUND OF THE INVENTION

The development of the “ultra electric” airplane is one of the major goals of the research and innovation policies implemented by the aeronautical industry. Electrical energy offers numerous advantages over mechanical, hydraulic or pneumatic energy, including improved integration of equipment, reduced maintenance costs, simplification of use, weight reduction, etc.

Large civil or military programs represent opportunities to introduce technological advances making it possible to replace traditional systems with electrical systems. The introduction, on civil airplanes, of electric flight controls, electrical braking, etc. may be cited among the most outstanding advances.

The development of electrical systems has brought about an escalation in electromechanical actuators which, in order to operate, require control facilities and power conversion facilities in particular. The control facilities are used to drive inverters associated with the electric motors of the electromechanical actuators, as a function of diverse settings and measurements (position of the rotor, angular speed, etc.). The power conversion facilities, for their part, are used to provide DC supply voltages (28 Volts for example) or AC supply voltages (115/200 Volts—400 Hertz for example) to the electrical equipment. These control and conversion facilities generally implement servocontrols which make it necessary to acquire measurements carried out by sensors of linear or angular position, speed, current, voltage, etc.

Each application requires control facilities and power conversion facilities having a certain number of characteristics dependent on the application (formulation of the control laws, monitoring, etc.). For each new application, it is therefore necessary to produce new equipment, this representing a significant cost in terms of development, certification and manufacture of the equipment, and introducing uncertainties as regards the performance of this new equipment in terms of safety and reliability.

### OBJECT OF THE INVENTION

The object of the invention is to reduce costs and times in the development of electrical systems while improving their reliability.

### SUMMARY OF THE INVENTION

With a view to achieving this aim, there is proposed a configurable, generic electrical facility comprising processing means for implementing at least one configured function, the processing means comprising a processing unit, memory blocks and predefined functional blocks being implemented in the processing unit, the processing unit comprising a memory module designed to store configuration data. According to the invention, the processing unit comprises routing means designed to organize exchanges of data between the blocks according to interconnection data included in the configuration data stored in the memory module.

Thus, it is possible to use an already developed, qualified and certified electrical facility to carry out a new function, solely by modifying the configuration data transmitted to the routing means of the processing unit. The routing means interconnect, parametrize and then control the predefined functional blocks so as to carry out the required configured function. This makes it possible to: reduce design costs, since the functional blocks, already produced, are reused; reduce the costs associated with the validation, verification and certification activities, since, for the new function, these relate only to the new configuration data; and reduce the uncertainties as regards equipment performance, since the performance of the processing units and functional blocks has already been proven.

The invention will be better understood in the light of the description which follows of a nonlimiting particular mode of implementation of the invention.

### BRIEF DESCRIPTION OF THE DRAWINGS

Reference will be made to the appended drawings, wherein

FIG. 1 schematically represents a configurable generic electrical facility of the invention;

FIG. 2 schematically represents an architecture of an FPGA and of a microcontroller of the electrical facility of the invention;

FIG. 3 schematically represents the way in which the electrical facility is configured so as to carry out a configured function.

### DETAILED DESCRIPTION OF THE INVENTION

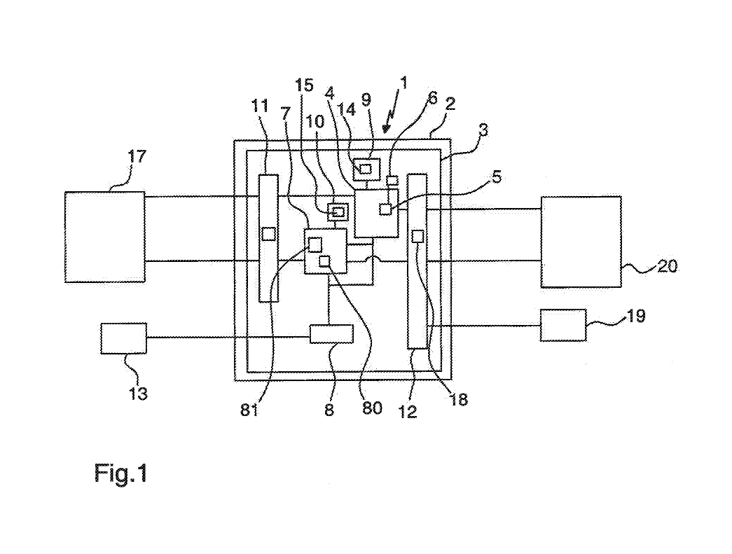

With reference to FIG. 1, a configurable generic electrical facility 1 of the invention comprises a casing 2 in which at least one electrical board 3 is mounted. This electrical board 3 comprises electrical components which include an FPGA 4 (“Field-Programmable Gate Array”) of SRAM (“Static Random Access Memory”) type implementing the invention comprising a random-access memory space 5 linked to a nonvolatile memory 6 situated in a component external to the FPGA (it would nonetheless be possible to provide a memory integrated into the FPGA). The electrical board 3 also comprises a microcontroller 7 comprising a processor 80 and a nonvolatile memory space 81, a power supply module 8, clock components 9, 10, communication interface components 11, and analog acquisition interface components 12.

The power supply module 8 of the electrical board 3 is connected to an external power supply source 13 and is designed to supply the components of the electrical board 3 by providing one or more appropriate supply voltages. The clock components 9, 10 comprise two quartz oscillators 14, 15, which provide a stabilized clock signal respectively to the FPGA 4 and to the microcontroller 7. The communication interface components 11, which comprise in particular a send/receive component 16 of an ARINC429 link type link, are used to shape digital signals exchanged between the FPGA 4, the microcontroller 7 and a first set of external equipment 17 outside the electrical facility 1. The analog acquisition interface components 12, which comprise an analog-digital converter 18, are designed to allow the FPGA 4 and the microcontroller 7 to command a second set of external equipment 20, and to have access measurements carried out by a set of external sensors 19 connected to the second set of external equipment 20.

The electrical facility 1 of the invention can be configured to carry out a control function for an electric motor of an electromechanical actuator, or a power conversion function making it possible to convert a DC or AC voltage into a DC or AC voltage (it would then be possible to have a DC/DC, DC/AC, AC/AC or AC/DC conversion).

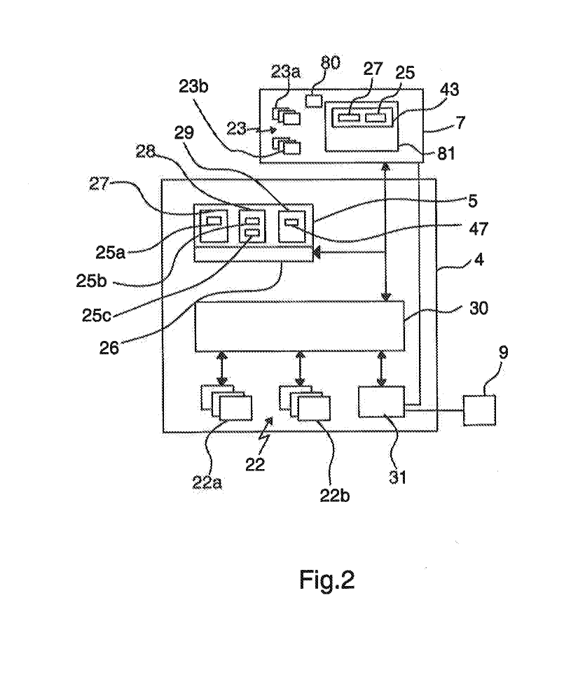

With this aim, with reference to FIG. 2, predefined functional blocks 22 are implemented in the FPGA 4. By “implemented” is meant that the functional blocks 22 of the FPGA 4 are coded by programmed codes stowed in memory areas, associated with the FPGA 4 and executed by the FPGA 4 to carry out operations. For an FPGA, execution consists in assembling elementary logic cells of which it is composed, and therefore in physically implanting a logical function.

To configure the electrical facility 1, a user must firstly load, a general configuration program 43 into the nonvolatile memory space 81 of the microcontroller 7. This general configuration program 43 contains configuration instructions 25 of the FPGA 4. This general configuration program 43 is modifiable by the user, and makes it possible to define the function which will be carried out by the electrical facility 1.

On booting the electrical facility 1, the configuration instructions 25 of the FPGA 4 are loaded by the microcontroller 7 into the random-access memory space 5 of the FPGA 4 via a memory controller 26 which manages all the exchanges of data with the random-access memory space 5 of the FPGA 4. The configuration instructions 25 of the FPGA 4 include control data 25a, interconnection data 25b, and parametrization data 25c. The control data 25a are stored in a first memory area 27 of the random-access memory space 5 of the FPGA 4, the interconnection data 25b and parametrization data 25c are stored in a second memory area 28 dedicated to the exchanges between the FPGA 4 and the microcontroller 7. The random-access memory space 5 of the FPGA 4 furthermore comprises a third memory area 29 for storing data exchanged 47 during the implementation of the configured function. The random-access memory space 5 then acquires the non-parametrized functional blocks 22 of the FPGA 4.

In the FPGA 4, the implementation of the configured function on the basis of the functional blocks 22 of the FPGA 4 is carried out by a router 30 linked to a sequencer 31, itself connected to the clock component 9 of the FPGA 4. The router 30 interconnects the command 22a and interface 22b blocks according to the interconnection data 25b. The router 30 is controlled by the control data 25a to activate the blocks 22 in such a way that the blocks 22 execute their operation, and to implement the exchanges of data between the blocks 22 so as to carry out the configured function. The router 30 comprises management means 32, whose role is to authorize or to refuse the activation of the blocks 22 according to parameters provided by the microcontroller 7. The predefined functional blocks 22 are parametrized by the router 30 according to the parametrization data 25c so that the operation that they carry out corresponds to the configured function. The router 30 is sequenced by the sequencer 31 according to a variable and parametrizable rate defined in the parametrization data 25c.

The functional blocks 22 comprise command blocks 22a and interface blocks 22b. The command blocks 22a are blocks which act on signals to transform them. The command blocks 22a include for example reference-frame transformation blocks, filtering blocks, etc.

The interface blocks 22b are intended to acquire or generate signals. The interface blocks 22b include for example analog-digital or digital-analog conversion blocks, whose sampling frequencies or resolutions are parametrizable, etc.

Each functional block 22 is therefore provided for carrying out an operation. These functional blocks 22 are independent, that is to say they do not need to be associated with other blocks in order to carry out the operation for which they are provided. These blocks are moreover parametrizable, that is to say it is possible to adapt the operation carried out to the function provided, for example by modifying values of thresholds, of output voltage, of frequency, etc.

Thus, by using predefined functional blocks stored in nonvolatile memories of an FPGA, it is possible to generate various algorithms to carry out particular functions by modifying solely configuration data that is Provided to the microcontroller, and therefore without modifying the code of the FPGA.

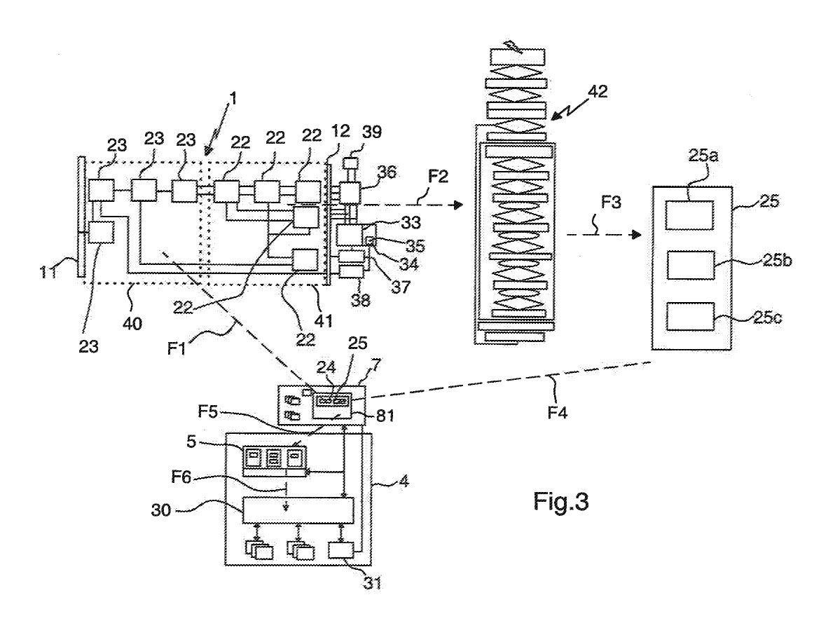

The implementation of a particular function is shown diagrammatically in FIG. 3. Here this is a control function for an electric motor 33 of an electromechanical actuator 34. The electric motor 33 is of synchronous, brushless and permanent magnets type. This electromechanical actuator 34 makes it possible to linearly displace an electromechanical lock rod 35. This type of lock can be used to lock thrust reversers in flight with the aim of preventing them from opening inopportunely.

The electrical facility 1 is controlled so as to drive the electric motor 33 and position the rod 35 of the actuator 34 as a function of a position setting transmitted to the microcontroller 7 via the communication interface components 11. The electrical facility 1 is moreover connected, via the analog acquisition interface components 12, to an inverter 36 driving the electric motor 33, as well as to a sensor of angular position 37 of the rotor of the electric motor 33, here a sensor of resolver type, and to a sensor of linear position 38 of the rod 35. The inverter 36 is supplied by a DC voltage source 39.

The control function is carried out by a regulating loop 41 implemented by the FPGA 4 with some of the functional blocks 22 of the FPGA 4.

The regulating loop 41 of the FPGA 4 is translated by the user into a state chart 42 (dashed arrow F1) and then transformed into configuration instructions 25 (dashed arrow F2). These data, which comprise control data 25a, interconnection data 25b and parametrization data 25c, are then stored in the nonvolatile memory space 81 of the microcontroller 7 (dashed arrow F3), and then transmitted to the random-access memory space 5 of the FPGA 4 (dashed arrow F4) and then to the router 30 of the FPGA 4 (dashed arrow F5) which, at a rate imposed by the sequencer 31, implements the FPGA regulating loop.

The invention is not limited to the particular embodiments which have just been described, but, quite to the contrary, covers any variant entering within the scope of the invention as defined by the claims.

Although it has been chosen to illustrate the invention by using an FPGA, it possible to use in place of the FPGA a component of ASIC (“Application-Specific Integrated Circuit”) type devised to be configurable.

Although it has been chosen to use a microcontroller integrated into the electrical facility to load the configuration instructions into the FPGA, it would have been possible to use a different component. It would also have been possible to make provision to load these configuration instructions from an external item of equipment outside the electrical facility.

Although it has been indicated that the management means lie within the router of the FPGA, they could be located elsewhere, and in particular in the microcontroller or any other component used to load the configuration instructions into the FPGA,

The list of functional blocks which is provided is of course not exhaustive, just like the list of components that are present on the electrical board of the electrical facility. Provision may also be made to mount these components on several electrical boards.

1. A configurable generic electrical facility comprising processing means for implementing at least one configured function, the processing means comprising a processing unit, memory blocks and predefined functional blocks being programmed in the processing unit, the processing unit being one FPGA or one ASIC and comprising a memory module designed to store configuration data, characterized in that the processing unit comprises routing means designed to organize exchanges of data between the blocks according to interconnection data included in the configuration data stored in the memory module.

2. The configurable generic electrical facility as claimed in claim 1, in which the routing means are controlled by control data included in the configuration data.

3. The configurable generic electrical facility as claimed in claim 1, in which the functional blocks are activated by control data included in the configuration data.

4. The configurable generic electrical facility as claimed in claim 1, in which the routing means are furthermore designed to parametrize the functional blocks according to parametrization data included in the configuration data.

5. The configurable generic electrical facility as claimed in claim 1, in which the processing unit furthermore comprises synchronization means designed to sequence the routing means according to a parametrizable rate.

6. The configurable generic electrical facility as claimed in claim 1, in which the processing unit furthermore comprises management means designed to authorize or refuse an activation of the functional blocks.

7. The configurable generic electrical facility as claimed in claim 1, in which the processing unit comprises at least one FPGA.

8. The configurable generic electrical facility as claimed in claim 1, in which the processing unit comprises at least one ASIC.

9. The configurable generic electrical facility as claimed in claim 1, in which the processing unit is designed to implement a control function for an electric motor.

10. The configurable generic electrical facility as claimed in claim 1, in which the processing unit is designed to implement a function for converting a DC or AC voltage into a DC or AC voltage.
